(19) United States
(12) Patent Application Publication
(10) Pub. No.: US 2007/0246372 A1
(43) Pub. Date: Oct. 25, 2007

(54) Electrochemical Machining Tool and Method for Machining a Product Using the Same

(75) Inventors: Rikuro Obara, Nagano-ken (JP); Tomoyuki Yasuda, Nagano-ken (JP)

Correspondence Address: Adduci, Mastriani & Schaumberg, 1200 Seventeenth Street, N.W., Washington, DC, 20036, US

(73) Assignee: MINEBEA CO., LTD., Kitasaku-gun, Nagano-ken (JP)

(21) Appl. No.: 11/661,869

(22) PCT Filed: Aug. 25, 2005
(86) PCT No.: PCT/US05/30072

§ 371 Date: Mar. 6, 2007

(30) Foreign Application Priority Data
Sep. 17, 2004 (JP) 2004-272505
Jul. 15, 2005 (JP) 2005-207881

(51) Int. Cl. B23H 3/04

(52) U.S. Cl. 205/662; 204/224 M

(57) ABSTRACT

An electrochemical machining tool (1) for electrochemical machining includes an electrode body (11). The electrochemical machining tool (1) and associated method can conduct simultaneous electrochemical machining of at least two of a radial dynamic pressure generating groove (43), an axial dynamic pressure generating groove (44), and a removal of a burr (42) associated with an oil pool (41). Electrochemical machining is performed with groove machining electrodes (12, 13) and deburring electrodes (14). A sleeve (4) machined using the electrochemical machining tool (1) and associated method has the radial dynamic pressure generating groove (43), the axial dynamic pressure generating groove (44), and the deburred oil pool (41). The sleeve (4) can be used in a hydrodynamic pressure bearing for use in a spindle motor of a hard disk drive.

### CROSS REFERENCE TO RELATED APPLICATION

This application is based on and incorporates by reference Japanese Patent Application No. 2004-272505, which was filed on Sep. 17, 2004 and Japanese Patent Application No. 2005-207881, which was filed on Jul. 15, 2005.

### BACKGROUND OF THE INVENTION

The present invention relates to electrochemical machining (ECM), and more specifically to an electrochemical machining tool and a method of machining using the electrochemical machining tool for manufacturing a high quality product, such as a bearing sleeve, at a low cost.

Conventional electrochemical machining equipment for deburring, as described, for example, in Japanese Unexamined Patent Application H10-277842, includes electrodes and a pulse current supply with a direct current power supply and a control device for applying a pulse current to a workpiece and to the electrodes. The electrodes include machining electrodes for deburring the workpiece and electrodes for detecting the position of the workpiece. An electrolyte is supplied between the workpiece and the electrodes, and the workpiece is aligned at a designated position relative to the electrodes.

With regard to the direct current power supply, the positive terminal (+) is connected to the workpiece, and the negative terminal (−) is connected to the workpiece machining electrodes and to the electrodes for detecting the workpiece position via the control device. It should be noted however, that the above document describes the workpiece machining electrodes for deburring and the pulse current supply as general concepts not easily practiced by one of ordinary skill in the art.

It is also known, as described for example in Japanese Unexamined Patent Application 2000-198042, that during electrochemical machining ultrasonic oscillation having an approximately uniform intensity can be directly propagated to the internal wall surface of the processing hole of the workpiece using a hone electrode tool having a structure that serves as both a hone tool for ultrasonic machining and an electrode tool for electrochemical machining. At the same time, an electrochemical effect is applied based on the electrochemical machining on the internal wall surface of the processing hole of the workpiece. As a result, parts having recesses where a conventional brush would not reach are effectively cleaned due to the action of the ultrasonic oscillation and the electrochemical effect. Metal chips and burrs, such as fine particles and shavings, can be effectively removed.

Further, it is known that, during conventional electrochemical machining including electrochemical deburring and electrochemical polishing processes, either one of the deburring or polishing processes can be carried out individually or both can be carried out simultaneously. Further, the electrolyte used in machining can be composed in a certain manner to achieve specific results associated with machining while ensuring that the electrolyte has stable conduction properties. For example, the electrolyte can include an oxidizing reagent capable of promoting surface oxidation in order to dissolve the metal surface of the workpiece to be machined, a polarization enhancer capable of maintaining the concentration polarization, and an inhibitor capable of inhibiting corrosion of the metal surface of the workpiece by the etching component. Japanese Unexamined Patent Application H07-316899 describes an electrolyte solution including one or a combination of electrolytes having one, two, or all three of the oxidizing reagent, the polarization enhancer or the inhibitor.

Still further, as described for example in Japanese Unexamined Patent Application H11-207530, electrochemical machining equipment may have processing electrodes configured to form a groove with a designated shape by electrochemical machining of an inner circumferential surface of a sleeve member. The processing electrodes can include groove machining electrodes capable of forming one or more grooves and finishing electrodes capable of carrying out a finishing process in which the sleeve member and the processing electrodes are moved in a designated relative direction, the groove machining electrodes form a groove on the inner circumferential surface of the sleeve member, and the finishing electrodes finish the inner circumferential surface.

However, while the above discussed reference generally describes machining of a radial dynamic pressure generating groove on the inner circumference of a sleeve, it fails to describe machining of an axial dynamic pressure generating groove at a designated position on the edge of the sleeve.

### SUMMARY OF THE INVENTION

To overcome the above limitations of known machining tools and processes, the present invention provides an electrochemical machining tool and machining process using the electrochemical machining tool described herein, that are capable of producing a high quality machined product at a low cost. More specifically, the electrochemical machining tool and machining process of the present invention reduces the number of steps associated with machining a workpiece such as a hydrodynamic pressure bearing sleeve, as placement or setting of the workpiece sleeve, and setting of the electrochemical machining tool, need only be performed once.

As noted, high quality and low cost manufacturing of workpieces such as bearing sleeves can be achieved by reducing the number of set-up related procedures and other procedures used for sleeve manufacturing. For example, the piece and electrochemical machining tool can be set up once, and procedures can be conducted with an electrochemical machining tool in accordance with the present invention to simultaneously or selectively perform machining of a radial dynamic pressure generating groove at a designated position on the inner circumferential surface of the workpiece, machining of an axial dynamic pressure groove at a designated position on the edge surface of the piece or sleeve, and deburring to remove machine processed burrs at an oil pool on the inner circumferential surface of the piece or sleeve.

It will be appreciated that the electrochemical machining tool and machining process can be used to machine workpieces and thereby produce products machined for demanding high speed, high accuracy applications, such as in a hydrodynamic pressure bearing capable of use in a hard disk spindle motor. Thus, in describing the electrochemical machining tool and machining process of the present invention, while the focus of the description will be on singular aspects of the present invention such as the formation of a radial dynamic pressure generating groove and axial dynamic pressure generating groove, a series of such grooves are formed on various surfaces as will be described herein for operation of, for example, a sleeve for a hydrodynamic pressure bearing. In describing the inventive electrochemical machining tool and method, the term workpiece may be used in place of sleeve since, in producing a product such as a sleeve, the tool and method of the present invention are applied to a workpiece, such as a piece of metal stock or the like, in accordance with the invention.

The electrochemical machining tool includes an electrode body, which can be configured to carry out any of the electrochemical machining procedures, such as axial groove machining, radial groove machining, and deburring, and further includes an insulated guiding tool having an electrolyte passage forming function and a positioning function for locating the machining electrodes relative to the workpiece or sleeve. In one embodiment, the electrode body is provided with electrochemical machining electrodes for machining an axial and a radial groove, and an electrochemical deburring electrode. In such an embodiment, all machining processes can be carried out simultaneously.

The electrochemical machining tool is configured to move reciprocally back and forth as necessary along an axis, such that the electrochemical machining tool can move away from or move toward and contact a workpiece such as a sleeve, which can be supported by a supporting tool. Very close contact can be achieved by way of pressing the edge of the guiding tool against the edge of the sleeve on which the axial dynamic pressure groove is to be formed, or against the top surface of the supporting tool. With the edge of the guiding tool pressed accordingly, an electrochemical machining gap can be assured for containing a flow of electrolyte.

More specifically, the guiding tool can have a projecting portion configured to be pressed together with the edge of the workpiece on which the axial dynamic pressure groove is to be formed, or with the edge of the workpiece supporting tool in order to assure the electrochemical machining gap for forming an electrolyte passage. The guiding tool and electrode body can be made movable relative to each other by a sliding mechanism and a screw to enable the two components to be adjusted related to one another. Therefore when, for example, the projecting portion is worn out, the guiding tool and the electrode body can be readjusted to ensure close contact and pressure is maintained during operation. Accordingly, by changing the relative position of the guiding tool and the electrode body, they can be readjusted relative to each other.

In accordance with a first embodiment of the present invention, an electrode body of the electrochemical machining tool can include machining electrodes configured to simultaneously form an axial dynamic pressure generating groove on the edge of the workpiece, a radial dynamic pressure generating groove on the inner circumferential surface of the workpiece and can remove the machined burrs of an oil pool. The machined burrs are associated with separate machining of the oil pool, which is mechanically machined on the inner circumferential surface of the workpiece. The oil pool formed by the mechanical machining can be provided anywhere on the inner circumferential surface of the workpiece. For example, it can be mechanically machined on the inner side between radial dynamic pressure generating grooves, or on the external side of the radial dynamic pressure generating grooves.

Alternatively, the electrode body of the electrochemical machining tool can include machining electrodes configured to simultaneously form an axial dynamic pressure generating groove on the edge of the workpiece and a radial dynamic pressure generating groove on the inner circumferential surface of the workpiece. The deburring to remove the machined burrs of the oil pool is performed separately.

In accordance with a second embodiment of the present invention, an electrode body of the electrochemical machining tool can include electrochemical machining electrodes configured to simultaneously form an axial dynamic pressure generating groove on the edge of the workpiece, and to electrochemically deburr or remove the machined burrs of the oil pool, which are mechanically machined on the inner circumferential surface of the workpiece. Electrochemical machining of a radial dynamic pressure generating groove on the inner circumferential surface of the workpiece is performed separately.

In accordance with a third embodiment, the electrode body of the electrochemical machining tool can include machining electrodes configured to simultaneously form a radial dynamic pressure generating groove on the inner circumferential surface of the workpiece and to deburr or remove the machined burrs of the oil pool. Electrochemical machining of an axial dynamic pressure generating groove on the edge of the workpiece is performed separately.

The electrode body of the electrochemical machining tool of the present invention, and the ECM methods described herein can produce a sleeve. The sleeve is manufactured, for example, from a piece of metal stock by electrochemical machining using the electrochemical machining tool of the present invention. Alternatively, the sleeve can further embody a hydrodynamic pressure bearing having the above described sleeve for use in a spindle motor, such as a hard disk spindle motor.

The electrochemical machining tool and electrochemical machining method of the present invention allow axial dynamic pressure generating groove machining at a designated position of the edge of the workpiece, radial dynamic pressure generating groove machining at a designated position of the inner surface of the workpiece, and deburring machining of the oil pool on the inner surface of the workpiece to be conducted simultaneously as a single process while the positions of the workpiece and machining electrodes are set only once. Depending on the individual instance, the electrochemical machining tool and the electrochemical machining method allow flexible handling of the workpiece by allowing simultaneous or sequential procedures or a combination thereof to be performed as noted above.

For example, axial dynamic pressure generating groove machining and deburring machining having similar electrochemical machining conditions can be carried out first, and then radial dynamic pressure generating groove machining can be carried out. As a result, the number of individual process steps can be reduced as compared to the prior art where electrochemical machining is carried out one process step at a time. Moreover, in accordance with the present invention, the workpiece and machining electrodes remain stationary while the position of the workpiece and the machining electrodes are set, thereby maintaining and not reducing precision. Still further, the prior art brushing process typically required after the deburring process can be omitted, allowing further reduction in cost and maintaining or improving precision.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1A is a diagram illustrating a cross-sectional view including parts of an electrochemical machining tool and sleeve supporting tool in accordance with one embodiment of the present invention.

FIG. 1B is a diagram illustrating another cross-sectional view including parts of an electrochemical machining tool and sleeve supporting tool in accordance with another embodiment of the present invention.

FIG. 2 is a diagram illustrating one of the two cross-sectional views of FIG. 1A and FIG. 1B, including parts of an electrochemical machining tool in accordance with one embodiment of the present invention.

FIG. 3 is a diagram illustrating a cross-sectional view including parts of an electrochemical machining tool in accordance with another embodiment of the present invention.

FIG. 4 is a diagram illustrating a magnified view of an oil pool and deburring electrodes in accordance with an embodiment of the present invention.

FIG. 5 is a diagram illustrating a schematic view of machining electrodes and an electrolyte passage forming device in accordance with an embodiment of the present invention.

FIG. 6 is a diagram illustrating a schematic view of an electrode body showing machining electrodes in accordance with an embodiment of the present invention.

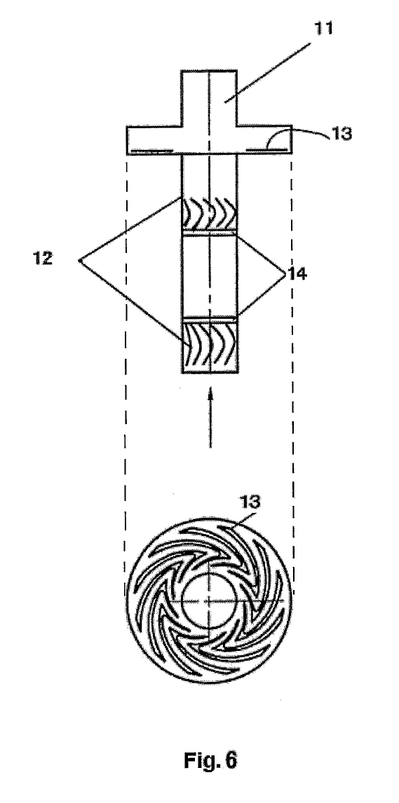

FIG. 7 is a diagram illustrating a perspective view of an exemplary sleeve machined in accordance with various embodiments of the present invention.

FIG. 8 is a diagram illustrating a hydrodynamic pressure bearing using a sleeve manufactured with the electrochemical machining tool and method in accordance with various embodiments of the present invention.

### DETAILED DESCRIPTION OF THE PREFERRED EMBODIMENTS

The present invention will now be described in detail in accordance with the drawings. The illustration and description of some components are omitted where their inclusion would not be necessary for one skilled in the art to understand the present invention.

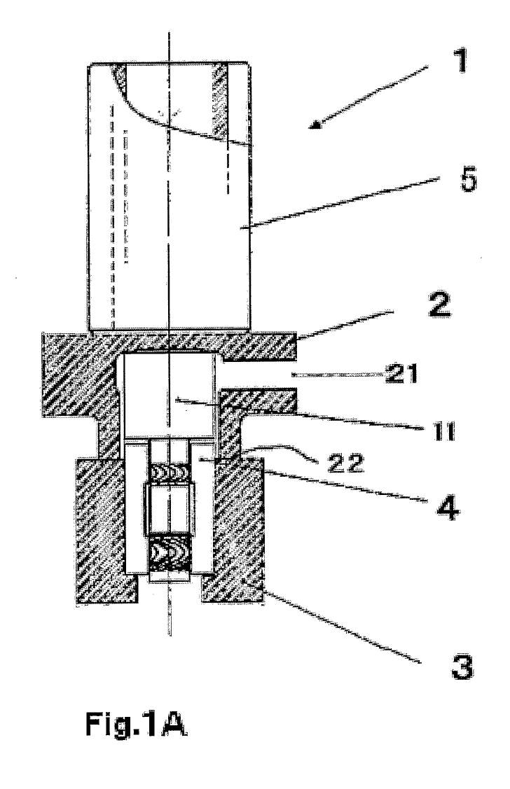

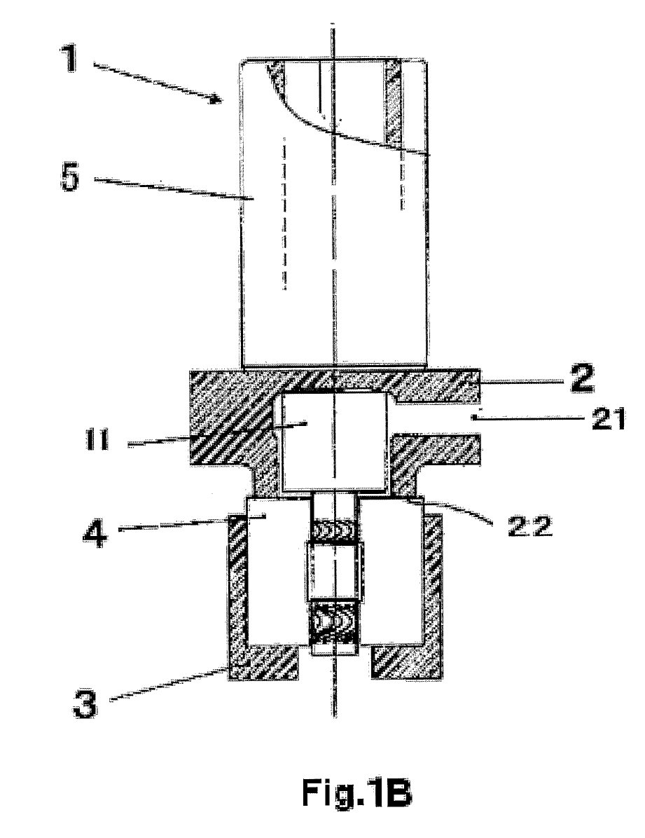

FIG. 1A and FIG. 1B show two views of electrochemical machining tool 1. A projecting portion 22 of an insulated guiding tool 2 shown in FIG. 1A rests against a sleeve supporting tool 3. As shown in FIG. 1B, the projecting portion 22 rests against a workpiece such as a sleeve 4.

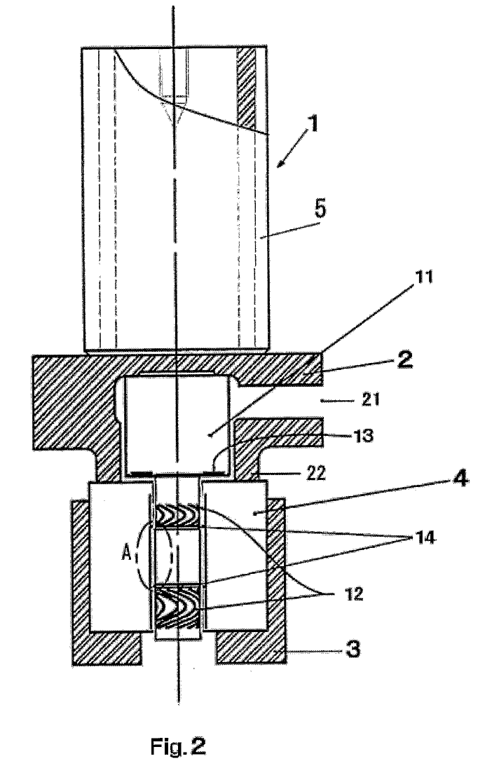

As shown with reference to FIG. 1A, FIG. 1B and FIG. 2, the electrochemical machining tool 1 includes an electrode body 11, a machining electrode 12 for forming a radial dynamic pressure generating groove in the sleeve 4, a machining electrode 13 for forming an axial dynamic pressure generating groove in the sleeve 4, and a deburring machining electrode 14 for removing burrs at, for example, an oil pool on the inner circumferential surface of the sleeve 4, the burrs resulting from mechanical machining of the sleeve 4. The electrochemical machining tool 1 can further include an insulated guiding tool 2, an electrolyte inlet 21, a projecting portion 22, and a sleeve supporting tool 3. These and other components will be described in greater detail hereinafter. It will be appreciated that, as noted, the sleeve 4 can be considered a workpiece and will be referred to as such interchangeably here in. Reference to the exemplary sleeve 4 can be made, for example, to a sleeve having axial and radial dynamic pressure generating grooves such as for use in a hydrodynamic pressure bearing.

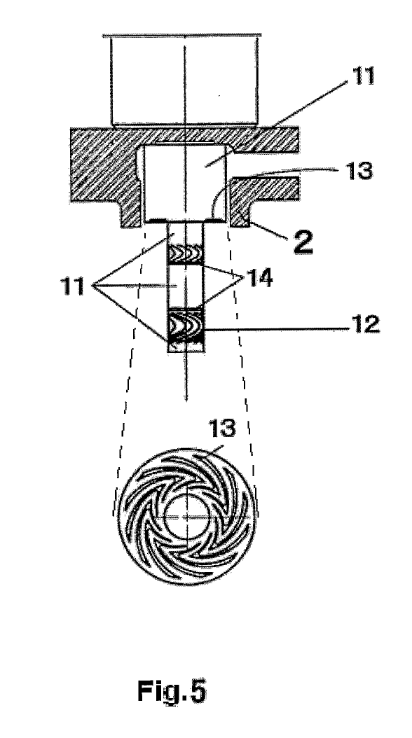

FIG. 5 shows the electrode body 11, the machining electrode 12, the machining electrode 13, and the deburring electrode 14. The machining electrodes 12, 13 and 14 can be configured to remove sludge through inversion switching of a current that can be applied to the machining electrode 13, the machining electrode 12, and the deburring electrode 14.

As noted, the present invention allows simultaneous machining in connection with an axial dynamic pressure generating groove machining process conducted at a designated position on the edge of the workpiece, a radial dynamic pressure generating groove machining process conducted at a designated position on the inner circumferential surface of the workpiece, and a deburring machining process configured to remove machine processed burrs at, for example, an oil pool on the inner circumferential surface of the workpiece.

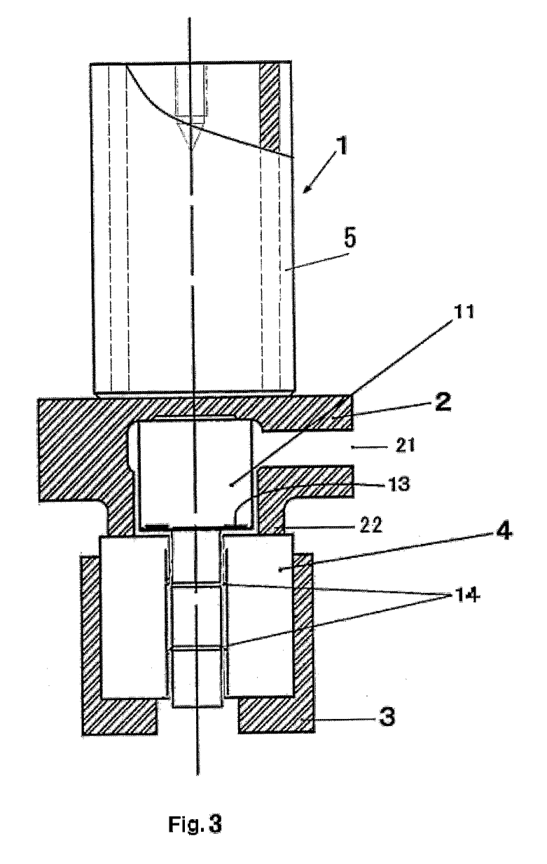

Alternatively, the axial dynamic pressure generating groove electrochemical machining and electrochemical deburring of an oil pool having similar electrochemical machining conditions can be carried out simultaneously using the electrode body 11, followed by a separate step of radial dynamic pressure generating groove electrochemical machining using, for example, another electrode body (not shown). It should be noted that, in accordance with the present embodiment, the electrode body 11 can include only the machining electrode 13 as shown, for example, in FIG. 3, and the deburring electrode 14 configured to remove burrs such as machine processed burrs. The subsequent radial dynamic pressure generating groove machining at a designated position on the inner circumferential surface of the workpiece can be carried out using a separate electrode body including only the machining electrode 12.

Furthermore, the radial dynamic pressure generating groove machining at a designated position on the inner circumferential surface of the workpiece can be carried out first, followed by simultaneous machining of the axial dynamic pressure generating groove, and the deburring.

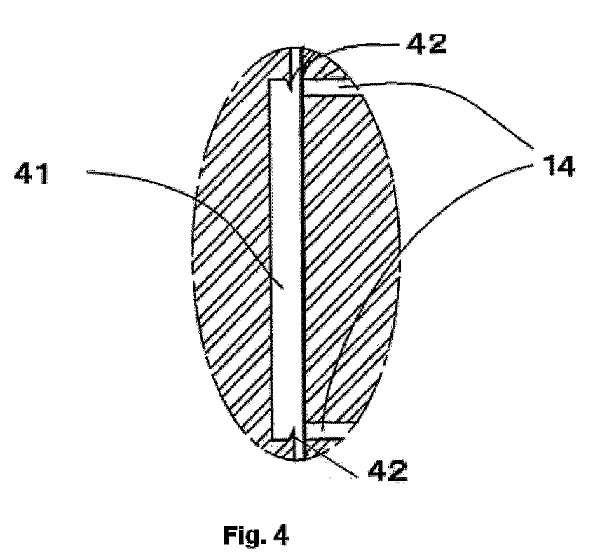

It should be noted that after mechanical machining of the inner circumferential surface of the sleeve 4 is carried out and an oil pool 41 is formed in the sleeve 4 as shown, for example, in FIG. 4, a machined burr 42 remains on the machined portion. The electrode body 11 of the present invention can be provided with the deburring electrode 14 to remove the machined burr 42 by electrochemical machining.

The electrochemical machining tool 1 of the present invention can include, as shown for example in FIG. 2 and FIG. 3, the electrode body 11 on an edge thereof. The electrode body 11 can include a large diameter portion having a diameter smaller than the external diameter of the sleeve 4 and larger than the internal diameter of the sleeve 4, and a small diameter portion having a diameter slightly smaller than the internal diameter of the sleeve 4. The machining electrode 13, which is configured to form the axial dynamic pressure generating groove at a designated position on the edge of the sleeve 4, is provided on the surface of the large diameter portion, and the machining electrode 12, which is configured to form a radial dynamic pressure generating groove on the inner circumferential surface of the sleeve 4, and/or deburring electrode 14 configured to remove machine processed burrs at, for example, an oil pool on the inner circumferential surface of the sleeve 4, are provided on the outer circumferential surface of the smaller diameter portion. The electrochemical machining tool 1 of the present invention can further include a bushing 5, which can be installed on the electrodes of processing equipment using a screw or the like. In addition, the surface of the electrode body 11 coming into contact with the electrolyte is coated with an insulation coating except on the machining electrodes 12, 13 and 14.

The electrochemical machining tool 1 of the present invention includes the electrode body 11, and further includes an insulated guiding tool 2 having an electrolyte passage forming function and an electrode positioning function for locating the electrode body 11 and the sleeve 4. The electrochemical machining tool 1 can move reciprocally back and forth along an axis, as required, to a designated position and the sleeve 4 can freely be installed and removed. The movement of the electrochemical machining tool 1 assures the flow of the electrolyte in the electrochemical machining gap by closely contacting the edge of the insulated guiding tool 2 to the axial dynamic pressure groove side edge of the sleeve 4, which can be supported by supporting tool 3, or to the top edge of the supporting tool 3 with a certain pressure. Accordingly, leakage of the electrolyte to locations other than the electrochemical machining gap is prevented.

More specifically, the insulated guiding tool 2, which is mounted on the electrode body 11 as will be described in greater detail hereinafter, can move back and forth along with the electrochemical machining tool 1. The insulated guiding tool 2 can be positioned to come into close contact with the supporting tool 3 by pressing together the projecting portion 22 of the insulated guiding tool 2, which is the portion projecting slightly from the large diameter portion of the electrode body 11, and the edge of the supporting tool 3 for supporting the sleeve 4, as can be seen, for example, in FIG. 1A. Alternatively, the insulated guiding tool 2 can be configured to come into close contact, for example with the sleeve 4, by pressing together the projecting portion 22 of the insulated guiding tool 2 and the edge of the sleeve 4, supported as can be seen for example in FIG. 1B.

By pressing the projecting portion 22 of the insulated guiding tool 2 in the above described manner, an electrolyte passage in the sleeve machining portion is formed, and the electrolyte can be introduced from the inlet 21 of the insulated guiding tool 2, allowing electrochemical machining of the designated portion of the edge and inner circumferential surface of the sleeve 4. It should be noted that the insulated guiding tool 2 can be formed using commercially available ceramic or commercially available synthetic resin. It will be appreciated that synthetic resin is preferably used to achieve a desired flexibility, since flexibility of the projecting portion 22 of the insulated guiding tool 2 makes it difficult for the electrolyte to leak when the insulating guiding tool 2 is placed into close contact under a pressure with the edge of the supporting tool 3 or the sleeve 4 as noted above.

In addition to movement of the insulated guiding tool 2 as described above, the insulated guiding tool 2 and the supporting tool 3 for the sleeve 4 can move back and forth, allowing the projecting portion 22 of the insulated guiding tool 2 to come into contact under a pressure with the edge of the sleeve 4 or the edge of the supporting tool 3 for the sleeve 4. Consequently, the electrolyte can be introduced from the inlet 21 of the electrolyte passage without leakage, and creating an electrolyte passage in the sleeve machining portion, and therefore, allowing electrochemical machining of the designated portion of the edge and inner circumferential surface of the sleeve 4.

To better understand how electrochemical machining and formation of the electrolyte passages is accomplished as described herein above, several observations can be made with reference to the electrode body 11 as shown in FIG. 5. The electrochemical machining tool 1 of the present invention has a basic structure of the electrode body 11 and the insulated guiding tool 2. The insulated guiding tool 2 is mounted on the electrode body 11 and movement of the insulated guiding tool 2 and the electrode body 11 can be conducted as described above.

It should be noted however that the projecting portion 22 can become worn, for example, since the projecting portion 22, as shown in detail in FIG. 2 and FIG. 3, is pressed against the axial dynamic pressure groove side edge of the sleeve 4 or the edge of the supporting tool 3 for the sleeve 3. Accordingly, the insulated guiding tool 2 and the electrode body 11 can be made relatively movable using a sliding mechanism and a screw, such as bushing 5 and a corresponding screw as described above. It should be noted that the bushing 5 is used to attach the electrochemical machining tool to the electrochemical machining equipment. Further, when the machining electrodes are viewed from the smaller diameter side, the axial dynamic pressure generating groove machining electrode 13, which forms the axial dynamic pressure generating groove, are configured in the manner shown, for example, at the bottom of FIG. 5.

It will be appreciated by those of skill in the art that conductive materials are used for the electrodes to achieve the electrochemical machining results described herein. Examples of the electrode body material including the processing or machining electrodes used for the electrochemical machining tool of the present invention are copper alloys or iron alloys. An example of a copper alloy is brass, and an example of an iron alloy is austenitic stainless steel known in the art as steel having, for example, a Japanese Industrial Standards (JIS) designation of SUS303, SUS304, or the like. While many materials can be used as the insulation resin to insulate portions of the electrode body other than the electrodes, insulating material should have a high resistance against electrolytes such as NaNO₃ (sodium nitrate) and should provide a good adherence to the electrode body material. An epoxy resin, a urethane resin, or a polyimide resin should ideally be chosen, with epoxy resins exhibiting superior performance characteristics. The ideal base material for the exemplary workpiece such as the sleeve 4 can also be chosen from copper alloys or iron alloys. As noted above, an example of a copper alloy is brass, and an example of an iron alloy is austenitic stainless steel such as SUS303, SUS304, or the like.

While the next section presents detailed examples and embodiments, they are presented for illustrative purposes. The present invention is not limited by these embodiments.

In accordance with a first embodiment, radial dynamic pressure generating groove electrochemical machining, axial dynamic pressure generating groove electrochemical machining and electrochemical machining for deburring are carried out simultaneously using the electrochemical machining tool 1 of the present invention.

It will be appreciated that the oil pool 41 is formed by a mechanical machining process. The sleeve 4, which as noted is formed from a blank machined austenitic stainless alloy, will be electrochemically machined using the electrochemical machining tool 1 of the present invention.

As shown in FIG. 2, the electrochemical machining tool 1 of the present invention includes the insulated guiding tool 2 and the electrode body 11. The electrode body 11 includes the machining electrode 13 located on the large diameter portion thereof and configured to form an axial dynamic pressure generating groove on the edge of the sleeve 4, the machining electrode 12 located on the small diameter portion of the electrode body 11 and configured to form a radial dynamic pressure generating groove on the inner circumferential surface of the sleeve 4, and the deburring electrode 14 also located on the small diameter portion of the electrode body 11 and configured to remove the machined burr at the oil pool 41 of the inner circumferential surface of the sleeve 4. With reference to FIG. 4, it should be noted that the oil pool 41 is formed by mechanical machining, such as turning of the sleeve 4, on a lathe or the like. Deburring is carried out using the electrochemical machining tool 1 of the present invention, which as noted above can be made of austenitic stainless steel.

The electrochemical machining tool 1, the insulated guiding tool 2, the supporting tool 3, which hold the sleeve 4, can be set or placed into designated or predetermined positions. The sleeve 4 to be electrochemically machined is placed in the concave supporting portion of the supporting tool 3. The electrochemical machining tool 1 is then lowered and, with a certain amount of force, the edge of the projecting portion 22 of the insulated guiding tool 2 is pushed against the edge of the sleeve 4, assuring the flow of the electrolyte in the electrochemical machining gap for performing electrochemical machining.

It will be appreciated that by applying a machining voltage as will be described in greater detail hereinafter to the sleeve 4 and the electrode body 11 including the machining electrodes 12 and 13 and deburring electrode 14 thereon, the electrolyte in the electrochemical machining gap will carry a current from the electrode surface through the electrolyte to the sleeve 4 and react with the surface of the sleeve 4 to ionize and remove molecules associated with a localized surface of the sleeve 4 through an electrochemical reaction. The groove or grooves are thereby formed in the sleeve 4 corresponding to the exposed electrode patterns on the electrode body 11.

As is well known, the electrolyte can be recycled. For example, the electrolyte in the electrolyte bath can be supplied to a sludge removal device (not shown) for removing the sludge generated during the electrochemical machining. The electrolyte from which sludge is removed can be returned, recycled, or otherwise re-supplied to the electrolyte supplying source. The recycled electrolyte in the electrolyte supplying source can be supplied to the electrolyte bath with a supply pump (not shown). It should be noted that the inlet 21 of the electrochemical machining tool 1 of the present invention can include, as described for example in Japanese Unexamined Patent Application H11-207530 noted above, a well-known electrolyte recycling device to circulate the electrolyte in the electrolyte bath (not shown) during the electrochemical machining. The electrolyte is supplied to and from the electrolyte recycling device including, for example, a sludge removal device with a filter, a container tank to contain the electrolyte, and a supply pump to supply the electrolyte.

The electrochemical machining tool 1 can include an electrode body 11. The electrode body 11 can include the radial dynamic pressure generating groove machining electrode 12 as previously described, the axial dynamic pressure generating groove machining electrode 13, and the deburring electrode 14. A drive control unit and a drive control circuit (not shown) intervenes between the electrodes 12, 13 and 14 and a direct current power supply. The drive control circuit is used to apply a desired machining voltage to the electrodes 12, 13 and 14 through the electrode body 11. The insulated guiding tool 2 can move back and forth by way of a control means (not shown) and establish a position corresponding to the designated position of the sleeve 4 to be machined. The sleeve 4 is contained in the concave supporting portion of the supporting tool 3 and supported at the designated position.

By controlling the size of the small diameter portion of the electrode body 11 or the size of the inner diameter of the sleeve 4, the gap between the inner surface of the sleeve 4 and the electrodes 12, 13 and 14 of the electrode body 11 can be controlled to a distance of several tens of micrometers (μm) at the position where the center of the sleeve 4 and the center of the machining electrodes 12 and 14 coincide. The importance of control over the gap distance will be appreciated by one of ordinary skill in the art of ECM. In addition, regarding the gap between the electrode 13 and the edge of the supported sleeve 4, the height of the projecting portion 22 is set in advance so that the gap becomes several tens of micrometers (μm) in a state of close contact under a pressure. The edge of the projecting portion 22 of the insulated guiding tool 2 and the edge of the supported sleeve 4 are placed into close contact under a constant pressure, and are kept stationary. Electrolyte is fed to the electrochemical machining gap while the sleeve 4 and the electrochemical machining tool 1 are stationary.

It should be noted that the electrolyte supplied from the electrolyte supplying source (not shown) is fed into the inlet 21 of the insulated guiding tool 2. An electrolyte passage is formed from the gap between the axial dynamic pressure generating groove machining electrode 13 and the edge of the sleeve 4, to the gaps between the inner circumferential surface of the sleeve 4, the radial dynamic pressure generating groove machining electrode 12, and the deburring electrode 14. Electrolyte is thus able to flow through the passage such that electrochemical machining can be performed as described herein.

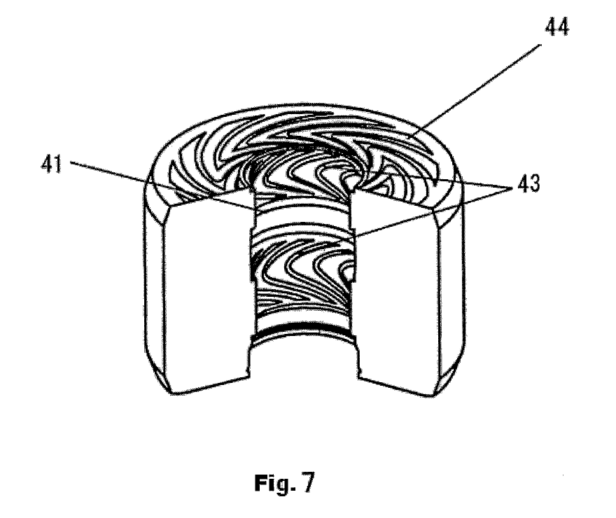

Between the electrodes 12, 13 and 14 and the direct current power source, the drive control circuit (not shown) is provided. Electrolyte is further supplied as noted above. By applying the machining voltage to the three electrodes, 12, 13 and 14 using the drive control circuit, an axial dynamic pressure generating groove 44 on the edge of sleeve 4, and a radial dynamic pressure generating groove 43 on the inner circumferential surface of the sleeve 4 are formed as shown in FIG. 7. In addition, the machined burr 42 at the oil pool 41 is removed.

Alternatively, radial dynamic pressure generating groove electrochemical machining and axial dynamic pressure generating groove electrochemical machining may be carried out simultaneously using the electrochemical machining tool 1 of the present invention. Unlike the first embodiment, electrochemical machining for deburring is performed separately. In this alternative scenario, the electrode body 11 only includes the radial dynamic pressure generating groove machining electrode 12 and the axial dynamic pressure generating groove machining electrode 13.

After the desired electrochemical machining is carried out, the sleeve 4 is removed and can be brushed or otherwise cleaned to remove the sludge caused by the electrochemical machining. The sleeve 4 can then be rinsed and dried. As a result, a sleeve 4 having a radial dynamic pressure generating groove and an axial dynamic pressure generating groove is obtained.

In accordance with a second embodiment, axial dynamic pressure generating groove electrochemical machining and deburring are carried out simultaneously, and radial dynamic pressure generating groove electrochemical machining is carried out separately.

As shown in FIG. 4, the oil pool 41 is formed by mechanical machining such as a turning process using a machine tool, a mill, a lathe, or the like, to prepare the sleeve 4, which is made of, for example, austenitic stainless steel. The electrochemical machining tool 1, as shown for example in FIG. 3, the insulated guiding tool 2 and the supporting tool 3, which holds or supports the sleeve 4, are placed or set at a predetermined or designated position. The sleeve 4 is contained in the concave supporting portion of the supporting tool 3. The electrochemical machining tool 1 is then lowered, and, with a certain amount of force, the edge of the projecting portion 22 of the insulated guiding tool 2 is pushed against the edge of the sleeve 4, such that a position of the machining electrode of electrochemical machining tool 1 is determined with certainty in the axial direction. Accordingly, the flow of the electrolyte in the electrochemical machining gap is assured.

The insulated guiding tool 2 can move reciprocally back and forth along an axis as necessary, by way of a control device (not shown) and can establish a position corresponding to the designated position of the sleeve 4 to be machined. The sleeve 4 is contained in the concave supporting portion of the supporting tool 3 and is thereby supported at the designated position. By controlling the size of the small diameter portion of the electrode body 11, or the size of the inner diameter of the sleeve 4, the gap between the inner surface of the sleeve 4 and the electrodes 12 and 14 of the electrode body 11 can be controlled to a distance of several tens of micrometers (μm) at the position where the center of the sleeve 4 and the center of the machining electrodes 12 and 14 coincide to facilitate electrochemical machining as described herein.

In addition, regarding the gap between the electrode 13 and the edge of the sleeve 4, the height of the projecting portion 22 can be set in advance so that the gap becomes several tens of micrometers (μm) when the projecting portion 22 and the edge of the sleeve 4 are closely contacted under a pressure. The edge of the projecting portion 22 of the insulated guiding tool 2 and the edge of the supported sleeve 4 are placed into close contact under a predetermined pressure and held motionless in a stationary position. Electrolyte is fed into the electrochemical machining gap while the sleeve 4 and electrochemical machining tool 1 are stationary.

The electrochemical machining tool 1 of the present embodiment can include an electrode body 11 positioned at a front end or the edge thereof. The electrode body 11 can include the axial dynamic pressure generating groove machining electrode 13 and the deburring electrode 14. A radial dynamic pressure generating groove on the inner circumferential surface of the sleeve 4 is formed separately.

In the present embodiment, as noted above, the axial dynamic pressure generating groove electrochemical machining and deburring machining are simultaneously carried out. Using the drive control circuit described above (not shown), the machining voltage is applied to the axial dynamic pressure generating groove machining electrode 13 and the deburring electrode 14. As shown in FIG. 3, the electrochemical machining tool 1 includes the electrode body 11 with the machining electrode 13 configured to carry out the electrochemical machining of the axial dynamic pressure generating groove on the edge of the sleeve 4. The electrode body 11 further includes the deburring machining electrode 14 configured to remove the machined burr 42 at the oil pool 41 on the inner circumferential surface of the sleeve 4.

The electrolyte supplied from the electrolyte supplying source (not shown) can be fed from the inlet 21 of the insulated guiding tool 2. An electrolyte passage is formed from the gap between the axial dynamic pressure generating groove machining electrode 13 and the edge of the sleeve 4, to the gaps between the inner circumferential surface of the sleeve 4 and the deburring electrode 14. The electrolyte can thus flow through the gaps.

Between the electrodes 13 and 14 and the direct current power source, the drive control circuit (not shown) is provided as noted. The electrolyte can be supplied and, by applying the machining voltage to the two electrodes 13 and 14, for example using the driving circuit, an axial dynamic pressure generating groove 44 can be machined on the edge of sleeve 4 and the machined burr 42 at the oil pool 41 can be removed by deburring electrode 14. In a separate procedure, an electrochemical machining tool 1 using an electrode body 11 with only a radial dynamic pressure generating groove electrochemical machining electrode 12 can be used to machine a radial dynamic pressure generating groove.

After the desired electrochemical machining is carried out, the sleeve 4 is removed and can be brushed or otherwise cleaned to remove the sludge caused by the electrochemical machining. The sleeve 4 can then be rinsed and dried. As a result, a sleeve 4 having a radial dynamic pressure generating groove and an axial dynamic pressure generating groove is obtained.

In accordance with a third embodiment, an electrochemical machining tool of the present invention simultaneously performs an electrochemical machining process for forming a radial dynamic pressure generating groove and an electrochemical machining process for removing burrs occurring from a mechanical machining process. An electrochemical machining process for forming an axial dynamic pressure generating groove is performed separately.

The electrochemical machining tool 1 of the present embodiment corresponds to the electrochemical machining tool 1 as shown, for example, in FIG. 2, with the electrode 13, for machining an axial dynamic pressure generating groove, omitted. In other words, the electrochemical machining tool 1 has the electrode body 11 on a front end or edge thereof. The electrode body 11 includes the radial dynamic pressure generating groove machining electrode 12, and the deburring electrode 14. A drive control circuit (not shown) intervenes between the electrodes 12 and 14 and a direct-current power supply. By making use of the drive control circuit in a desired way, a voltage for the simultaneous machining and deburring processes can be applied to the electrodes 12 and 14. In such a configuration, the electrodes 12 and 14 of the electrochemical machining tool 1 can have highly accurate relative positions because the electrodes can be made closely at very precise positions on the same surface without being affected by the presence of the electrode 13. As a result, the overall accuracy of the electrochemical machining tool 1 is improved, and the setup operation during an electrochemical machining process becomes easier.

It will be appreciated that in accordance with the present embodiment, the electrochemical machining process for forming an axial dynamic pressure generating groove on the end surface of the sleeve is performed separately by using an electrochemical machining tool 1, of which the electrode body 11 has only electrode 13 for electrochemically machining an axial dynamic pressure generating groove. Except for the structural differences in the exemplary electrode body 11 described above in connection with the present embodiment, the machining method is the same as in the second embodiment, and the same results are obtained; therefore, a detailed explanation of the electrochemical machining process is omitted.

The electrochemical machining tool of the present invention, in accordance with the above described embodiments, can be used to manufacture a hydrodynamic pressure bearing as shown in FIG. 7 using the sleeve 4. As shown, it can be seen that the sleeve 4 can be configured in roughly a hollow cylindrical shape having edge surfaces at each end thereof, and inner and outer circumferential surfaces. The axial dynamic pressure generating groove 44 can be seen on one of the edge surface portions of the sleeve 4, the radial dynamic pressure generating groove 43 can be seen on the inner circumferential surface of the sleeve 4, and the oil pool 41 can be seen also on the inner circumferential surface of the sleeve 4.

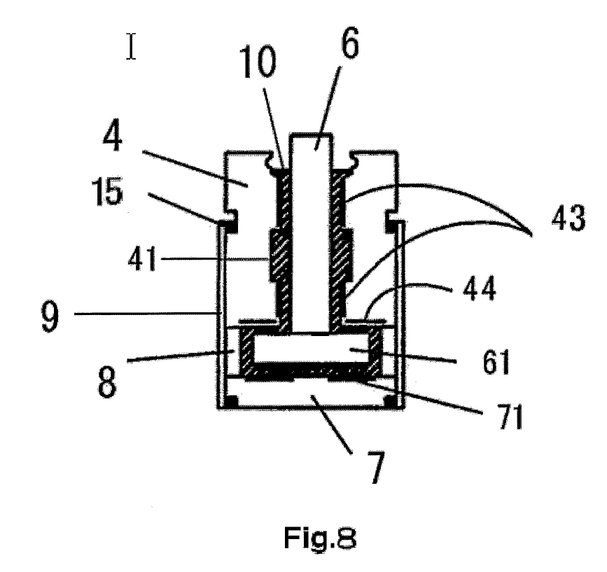

As shown in FIG. 8, the resulting hydrodynamic pressure bearing includes a radial dynamic pressure generating groove 43 located on the inner circumferential surface of the sleeve 4, and an axial dynamic pressure generating groove 44 located on an edge portion of the sleeve 4. The sleeve 4 can further include the oil pool 41, which can be obtained as described above, for example, in connection with the first, second, and third embodiments.

A rotary shaft 6 to which a flange 61 is fit on one end thereof, can be inserted or assembled within the sleeve 4 so that it rotates freely. An end cap 7 and a tubular sleeve 9 can be used to contain components of the hydrodynamic pressure bearing. The end cap 7 can be provided with axial dynamic pressure generating grooves formed using, for example, principles described herein, on an edge surface thereof. An outer circumference of the end cap 7 and an end portion of the tubular sleeve 9 can be welded to form a cup shape. The tubular sleeve 9 is fit to the outer circumference of the sleeve 4 of the hydrodynamic pressure bearing and is sealed in an airtight condition at the outer circumferential surface of hydrodynamic pressure bearing with an adhesive 15 so that the top and bottom edges of the flange 61 are facing respectively the axial dynamic pressure generating grooves 44 of sleeve 4 and the axial dynamic pressure generating grooves 71 formed on the end cap 7.

The distance between the end surface of the hydrodynamic pressure bearing and the surface of the end cap 7 can be configured using a spacer 8 to form a suitably sized gap, space, cavity, or the like in which the rotary shaft 6 and the flange 61 can be suspended. The space or gap formed with the hydrodynamic pressure bearing, the end cap 7, and the rotary shaft 6 including the flange 61 is filled with a lubricant oil 10 to promote lubrication and suspension of the rotary shaft 6 including the flange 61 by the generation of dynamic pressure in the oil 10 by the action of the dynamic pressure generating grooves discussed and described herein during rotation as will be further described.

When the rotary shaft 6 with the flange 61 rotates, axial and radial dynamic pressures are generated in the lubricant oil 10, between the rotary shaft 6 and the radial dynamic pressure generating grooves 43 on the inner circumferential surface of the sleeve 4, and between the flange 61 and the axial dynamic pressure generating grooves 44 formed on the edge portion of sleeve 4, and axial dynamic pressure generating grooves 71 formed on the end plate 7. By the lifting action associated with the dynamic pressures generated during rotation, the rotary shaft 6 with the flange 61 can freely rotate. It is important to note that while machining of an axial pressure generating groove and machining of a radial pressure generating groove are described herein in accordance with the invention, suspension of the rotary shaft 6 with the flange 61 are accomplished with a series of such grooves formed, in the above described manner, around, for example, the circumference of the sleeve 4, or around the edge surface of the sleeve 4 as shown, for example, in the figures.

The electrochemical machining tool and electrochemical machining method of the present invention allow radial dynamic pressure generating groove machining, axial dynamic pressure generating groove machining at a designated position of the inner surface of the sleeve 4, and deburring machining of the oil pool 41 at the inner surface of the sleeve 4 as a single process, while the positions of the sleeve 4 and the machining electrodes 12, 13 and 14 are set only once. Electrochemical machining of the radial dynamic pressure generating groove, axial dynamic pressure generating groove and burrs associated with the oil pool, and the resulting sleeve allow for superior mass production capacity leading to high industrial availability of related parts or subassemblies.

The disclosure is intended to explain how to fashion and use various embodiments in accordance with the invention and is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and modifications as are suited to the particular use contemplated, and which fall within the scope of the invention as determined by the appended claims, and all equivalents thereof, when interpreted in accordance with the breadth to which they are fairly, legally, and equitably entitled.

1. An electrochemical machining tool for machining a workpiece that is supported by a supporting tool, the electrochemical machining tool comprising:
an electrode body configured to simultaneously conduct at least two of: a first electrochemical machining of an axial dynamic pressure generating groove on the workpiece; a second electrochemical machining of a radial dynamic pressure generating groove located on the workpiece; and an electrochemical removing of a burr located on the workpiece, wherein the electrode body includes a plurality of electrodes; and
an insulated guiding tool configured to position the electrode body in relation to the workpiece and simultaneously form an electrolyte passage, the insulated guiding tool includes a projecting portion, and the electrochemical machining tool is configured to press the projecting portion against one of a top surface of the supporting tool and an edge of the workpiece to secure the flow of electrolyte in the electrolyte passage.

2. An electrochemical machining tool as set forth in claim 1, wherein when two of the first electrochemical machining, the second electrochemical machining, and the electrochemical removing of the burr are simultaneously conducted, the other of the first electrochemical machining, the second electrochemical machining, and the electrochemical removing of the burr is conducted separately.

3. An electrochemical machining tool as set forth in claim 1, wherein:
the workpiece is supported by a supporting tool; and
the insulated guiding tool includes an edge configured to press against one of a top surface of the supporting tool, and an edge of the workpiece, so as to secure the flow of electrolyte in the electrolyte passage.

4. (canceled)

5. An electrochemical machining tool as set forth in claim 1, wherein the first electrochemical machining of the axial dynamic pressure generating groove is performed on an edge of the workpiece.

6. An electrochemical machining tool as set forth in claim 1, wherein the second electrochemical machining of the radial dynamic pressure generating groove is performed on an inner circumferential surface of the workpiece.

7. An electrochemical machining tool as set forth in claim 1, wherein the electrode body is configured to simultaneously conduct:
the first electrochemical machining of the axial dynamic pressure generating groove on an edge of the workpiece, and
the deburring electrochemical machining of the burr.

8. An electrochemical machining tool as set forth in claim 1, wherein the electrode body is configured to simultaneously conduct:
the first electrochemical machining of the axial dynamic pressure generating groove on an edge of the workpiece, and
the second electrochemical machining of the radial dynamic pressure generating groove on an inner circumferential surface of the workpiece.

9. An electrochemical machining tool as set forth in claim 1, wherein the insulated guiding tool and the electrode body are movable relative to each other.

10. A method of performing electrochemical machining of a workpiece using an electrochemical machining tool, comprising:
simultaneously performing at least two of:
a first electrochemical machining of an axial dynamic pressure generating groove on the workpiece,
a second electrochemical machining of a radial dynamic pressure generating groove on the workpiece, and
a deburring electrochemical machining of a burr located on the workpiece.

11. A method as set forth in claim 10, wherein the electrochemical machining tool includes an electrode body, the method further comprising positioning the electrode body and the workpiece to form an electrolyte passage therebetween.

12. A method as set forth in claim 10, further comprising separately performing a remaining one of the first electrochemical machining of the axial dynamic pressure generating groove, the second electrochemical machining of the radial dynamic pressure generating groove, and the deburring electrochemical machining of the burr.

13. A method as set forth in claim 10, wherein the first electrochemical machining of the axial dynamic pressure generating groove and the deburring electrochemical machining of the burr are simultaneously performed.

14. A method as set forth in claim 10, wherein the first electrochemical machining of the axial dynamic pressure generating groove and the second electrochemical machining of the radial dynamic pressure generating groove are simultaneously performed.

15. A method as set forth in claim 10, wherein the workpiece includes a sleeve associated with a hydrodynamic pressure bearing.

16. A method as set forth in claim 15, wherein the hydrodynamic pressure bearing is associated with a spindle motor.

17. An electrochemical machining apparatus for performing one or simultaneously two or more of: an electrochemical machining of an axial dynamic pressure generating groove, an electrochemical machining of a radial dynamic pressure generating groove, and an electrochemical machining for removing burrs, the electrochemical machining of the axial dynamic pressure generating groove being performed at a predetermined location on an end surface of a sleeve, the electrochemical machining of the radial dynamic pressure generating groove being performed at a first predetermined location on an inner peripheral surface of the sleeve, and the burrs occurring from a mechanical machining process performed separately at a second predetermined location on the inner peripheral surface of the sleeve, the electrochemical machining apparatus comprising:
a sleeve holding device for holding the sleeve;
an electrode unit configured to perform the one or simultaneous two or more electrochemical machining processes; and
an insulating guide tool configured to:
form a pathway with the electrode unit and the sleeve for an electrochemical solution associated with the electrochemical machining processes, and
determine a position of an electrode relative to the sleeve,
wherein the electrochemical machining apparatus is configured to move along an axis so as to ensure that an end surface of the insulated guide tool is contacted under a pressure to one of an end surface of the axial dynamic pressure generating groove side of the sleeve and an upper end surface of the sleeve-holding device, and wherein an electrochemical solution thereby flows into the pathway.

18. The electrochemical machining apparatus according to claim 17, wherein the electrode unit comprises:
a machining electrode for performing the electrochemically machining the axial dynamic pressure generating groove on the end surface of the sleeve; and
a burr removal machining electrode for performing the electrochemically machining to remove the burrs occurring from the separate mechanical machining process, the second predetermined location including an oil containing section on the inner peripheral surface of the sleeve.

19. The electrochemical machining apparatus according to claim 17, wherein the electrode unit comprises:
a first machining electrode for performing the electrochemically machining the axial dynamic pressure generating groove on the end surface of the sleeve; and
a second machining electrode for performing the electrochemically machining the radial dynamic pressure generating groove on the inner peripheral surface of the sleeve.

20. The electrochemical machining apparatus according to claim 17, wherein the electrode unit comprises:
a machining electrode for performing the electrochemically machining the radial dynamic pressure generating groove on the inner peripheral surface of the sleeve; and
a burr removal machining electrode for performing the electrochemically machining to remove the burrs occurring from the separate mechanical machining process, the second predetermined location including an oil containing section on the inner peripheral surface of the sleeve.

21. The electrochemical machining apparatus according to claim 17, wherein the electrode unit comprises:
a first machining electrode for performing the electrochemically machining the axial dynamic pressure generating groove on the end surface of the sleeve;
a second machining electrode for performing the electrochemically machining the radial dynamic pressure generating groove on the inner peripheral surface of the sleeve; and
a burr removal machining electrode for performing the electrochemically machining to remove the burrs occurring from the separate mechanical machining process, the second predetermined location including an oil containing section on the inner peripheral surface of the sleeve.

22. The electrochemical machining apparatus according to claim 17, wherein the insulated guide tool includes a convex portion for assuring a gap for performing the machining process for forming axial dynamic pressure generating groove, the convex portion being contacted under the pressure to either the end surface of the axial dynamic pressure generating groove side of the sleeve or the upper end surface of the sleeve holding device.

23. The electrochemical machining apparatus according to claim 17, wherein the insulated guide tool and the electrode unit are relatively movable.
